(19) United States
(12) Patent Application Publication
(10) Pub. No.: US 2006/0232559 A1
(43) Pub. Date: Oct. 19, 2006

(54) Capacitive touchpad with physical key function

(76) Inventors: Yung-Lieh Chien, Taoyuan City (TW); Jia-Yih Lii, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/299,739

(22) Filed: Dec. 13, 2005

(30) Foreign Application Priority Data
Apr. 19, 2005 (TW) 094112438

(51) Int. Cl. G09G 5/00

(52) U.S. Cl. 345/168

(57) ABSTRACT

A capacitive touchpad with physical key function comprises a soft flexible first conductive layer; a second conductive layer; and a soft flexible insulator layer disposed between the first and the second conductive layers. The insulator layer has at least a through hole for the first conductive layer to connect to the second conductive layer while the touchpad is pressed and cause the voltages on the first or the second conductive layers to change and thus to trigger a predetermined key function.

### FIELD OF THE INVENTION

The present invention is related generally to a capacitive touchpad, and more particularly, to a capacitive touchpad with physical key function.

### BACKGROUND OF THE INVENTION

As shown in FIG. 1 and FIG. 2, a conventional key-type input apparatus 100 and 200 change the potential stage of I/O of an integrated circuit 104 by applying a force to press a key 102 to detect if the key 102 is pressed. When the key 102 is not pressed, the potential of the I/O of the input apparatus 100 is high; when the key 102 is pressed, the potential of the I/O is low. When the key 102 is not pressed, the potential of the I/O of the input apparatus 200 is low; when the key 102 is pressed, the potential of the I/O changes to high. Since the potential stage varies with the force to determine if the key is pressed, there's an advantage of precise operation and low power consumption.

As technology develops, the volumes of electronic devices get smaller, especially portable devices. But the size of a key-type input apparatus is limited due to the key, and becomes the barrier to minimize an electronic device. A touchpad that is thinner and lighter than a key is proposed as an input apparatus. FIG. 3 is a section of a conventional capacitive touchpad 300. The panel 302 and the substrate 306 are insulator. The conductive layer 308 is a first axis sensor, and the conductive layer 310 is a second axis sensor. An insulator layer 304 is disposed between the conductive layers 308 and 310 to separate the conductive layers 308 and 310. The insulator layer 304 and the conductive layers 308 and 310 can be treated as a capacitor. When a finger 312 touches the touchpad 300, the capacitance of the touched position changes, so the position of the finger 312 on the touchpad 300 is obtained. The sensing method of a capacitive touchpad can be referenced to U.S. Pat. No. 5,929,309. Since a capacitive touchpad 300 has the advantage of high resolution, it is proper to be used as a writing input apparatus. A capacitive touchpad 300 is operated using sensing method, it can't be operated as precise as a key-type input apparatus. A capacitive touchpad also has to scan continuously to sense the position of the finger and thus consumes much. Though there exists virtual key function on a touchpad, it also has to scan continuously to sense if a finger touches the virtual key.

Thus, an input apparatus with the advantages of physical keys and capacitive touchpad is required.

### SUMMARY OF THE INVENTION

There is one object of the present invention to provide a capacitive touchpad with physical key function.

According to the present invention, a capacitive touchpad with physical key function comprises a soft flexible first conductive layer under a panel; a second conductive layer and a soft flexible insulator layer between the first and the second conductive layers. There's a least one hole on the insulator layer. When a position corresponding to the hole is pressed, the first conductive layer deforms and connects to the second conductive layer. The voltage of the first or the second conductive layer changes and triggers a predetermined function.

The capacitive touchpad according to the present invention is like a physical key that changes the potential by pressing to trigger a key function. So the present invention has the advantages of a capacitive touchpad and a physical key.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a conventional key type input apparatus;

FIG. 2 is another conventional key type input apparatus;

FIG. 3 is a section view of a conventional capacitive touchpad;

FIG. 4 is an exploded view of a capacitive touchpad according to the present invention;

FIG. 5A is a section view along AA direction of the touchpad in FIG. 4;

FIG. 5B is another embodiment of the insulator layer 406 in FIG. 5A;

FIG. 6 is an illustration of the pressed touchpad in FIG. 5A;

FIG. 7 is another embodiment of the touchpad in FIG. 4;

FIG. 8 is an embodiment of a mobile phone or a phone using the structure in FIG. 4;

FIG. 9 is an expanded view and section view of the input apparatus in FIG. 8;

FIG. 10 is another embodiment of the structure in FIG. 4 used as an input apparatus;

FIG. 11 is an exploded view of anther capacitive touchpad according to the present invention;

FIG. 12 is embodiment of a mobile phone or a phone using the structure in FIG. 1 1;

FIG. 13 is an expanded view of the input apparatus in FIG. 12;

FIG. 14 is another embodiment of the structure in FIG. 11 used as an input apparatus;

FIG. 15 is an embodiment of a structural capacitive touchpad using the structure in FIG. 11;

FIG. 16 is another embodiment of the touchpad in FIG. 11; and

FIG. 17 is yet another embodiment of the touchpad in FIG. 11.

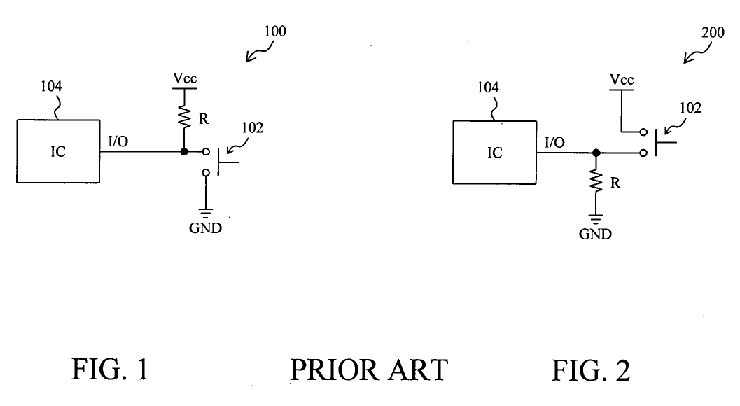

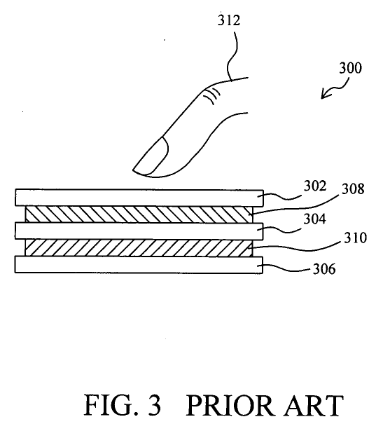

### DETAILED DESCRIPTION OF THE INVENTION

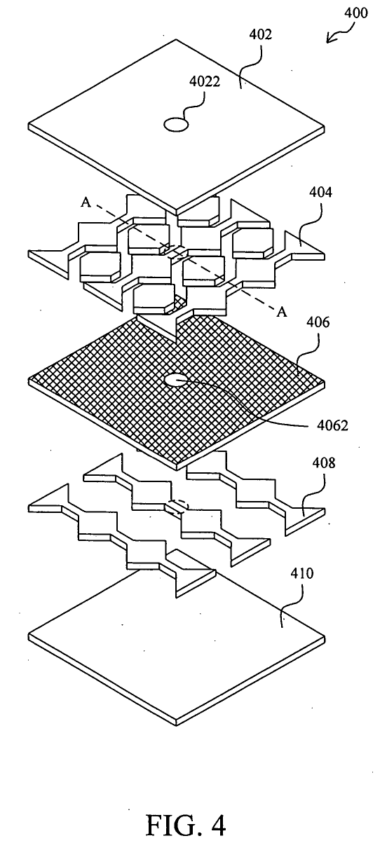

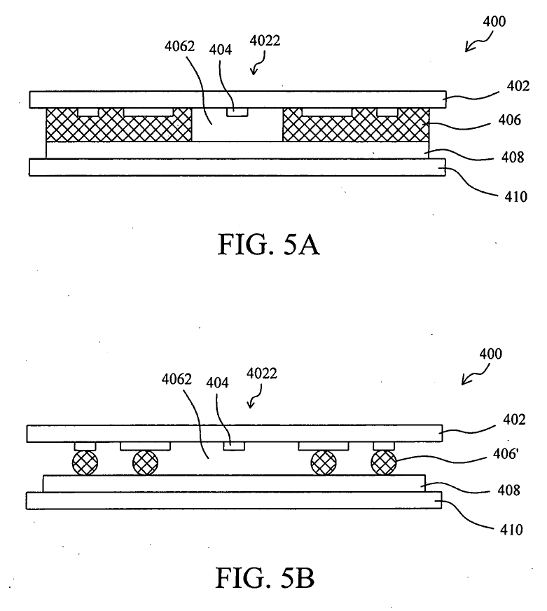

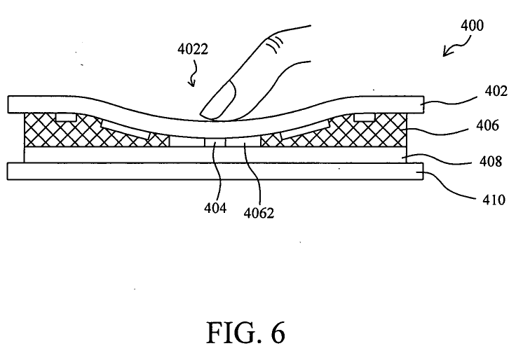

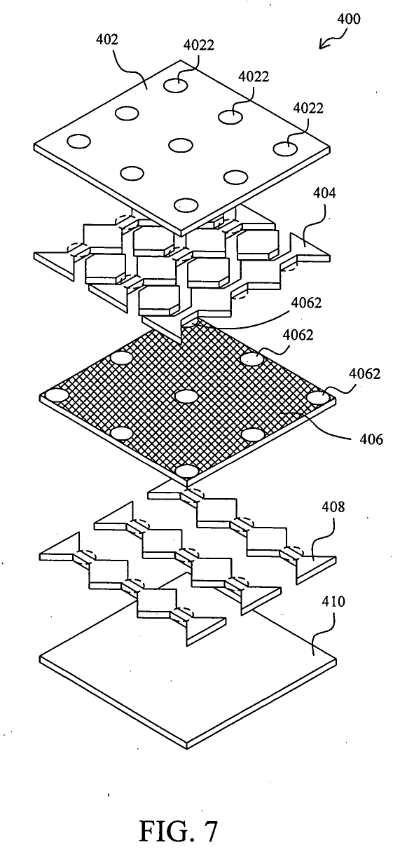

FIG. 4 is an exploded view of a capacitive touchpad 400 according to the present invention. FIG. 5A is a section view of the touchpad 400 along AA direction. In the capacitive touchpad 400, the conductive layers 404 and 408 used as Y-axis sensor and X-axis sensor are separated by the insulator layer 406 between the panel 402 and the substrate 410. As shown in FIG. 5B, in other embodiments, the insulator layer 406 may comprise a plurality of insulator balls 406′. The panel 302, conductive layers 404 and 408, and insulator layer 406 are all made of soft flexible material. The insulator layer 406 has a hole on the insulator layer 406. There is a key area 4022 on the panel 402 corresponding to the position of the hole 4062. When a user presses on the key area 4022, as shown in FIG. 6, the conductive layer 404 connects the conductive layer 408 through the hole 4022 of the insulator 406 and causes a change on the potential of conductive layer 404 or 408 and triggers a predetermined key function. The number and position of the key can be determined upon request, as shown in FIG. 7.

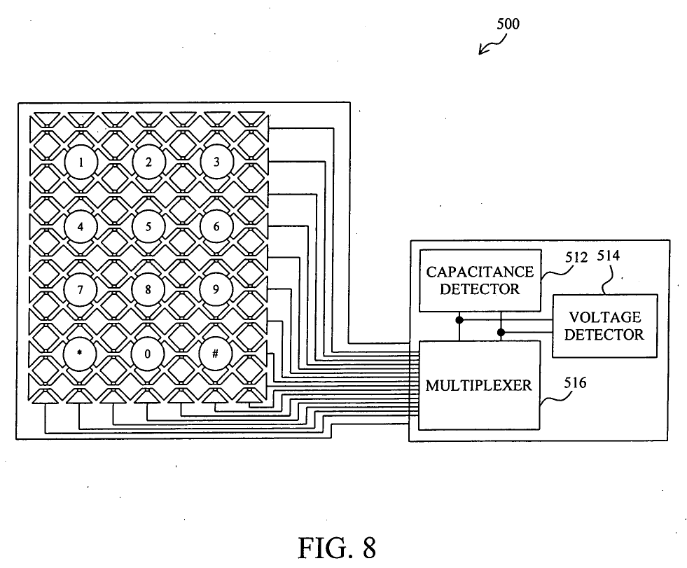

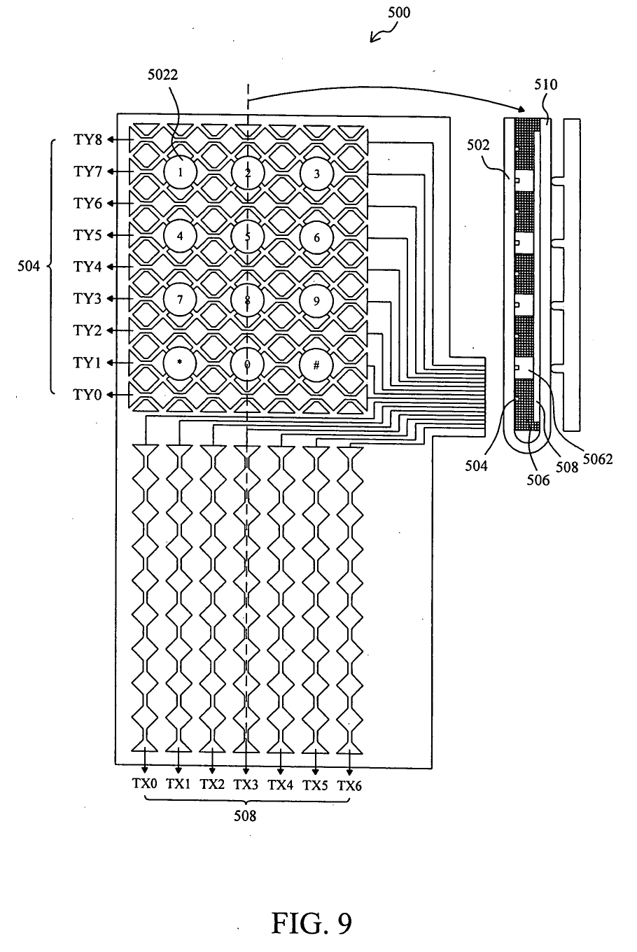

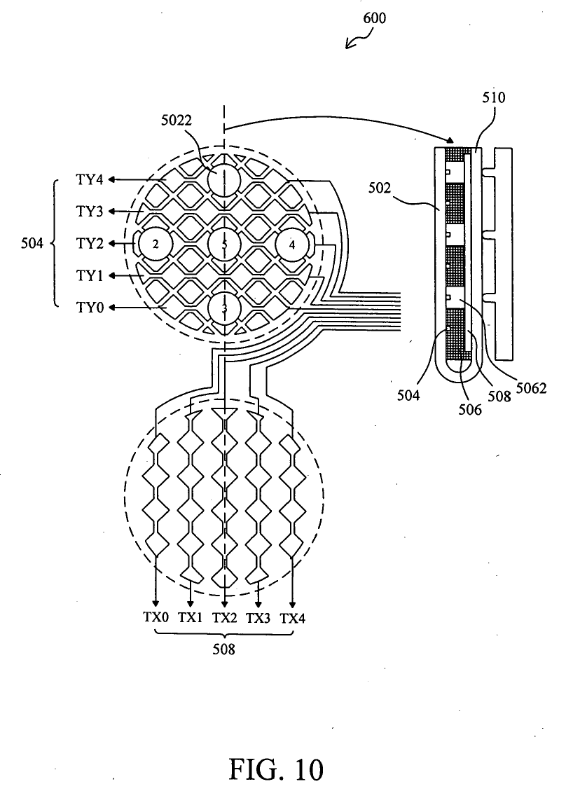

FIG. 8 illustrates an embodiment using the structure in FIG. 4 as the input apparatus 400 of a mobile phone or a phone. FIG. 9 is the expanded view and section view of the input apparatus 500. Please refer to FIG. 9, in the input apparatus 500, the conductive layer 504 and 508 used as the first axis sensor and the second axis sensor are disposed between the panel 502 and the substrate 510. An insulator layer 506 separates the conductive layers 504 and 508. There are pluralities of holes 5062 in the insulator layer 506 corresponding to the key area 5022 on the panel. Please refer to FIG. 8, a capacitive detector 512 couples to the wires TY0 to TY8 on the conductive layer 504 and the wires TX0 to TX6 on the conductive layer 508 through a multiplexer 516 to actively provide a current to charge and discharge the parasitic capacitor on the conductive layers 504 and 508. A voltage is further generated between the conductive layers 504 and 508. When a user's finger touches the panel 502, the parasitic capacitance at the touched place changes. The capacitance detector 512 detects the position of the changed capacitance to detect the position of the finger and the trace of movement to generate a corresponding response. The voltage detector 514 also couples to the wires TY0 to TY8 and TX0 to TX6 through the multiplexer 516 and provides a first voltage and a second voltage to the conductive layers 504 and 508. When a used wants to dial a phone, touching the key area 5022 on the panel 502 such that the conductive layer 504 touches the conductive layer 508. The potential detector 514 detects the changes on the first voltage of the conductive layer 504 or the second voltage of the conductive layer 508 and further determines the key area 5022 pressed by the user. When the present invention is utilized in different electronic devices, the shape and the number of keys vary, as the input apparatus 600 shown in FIG. 10.

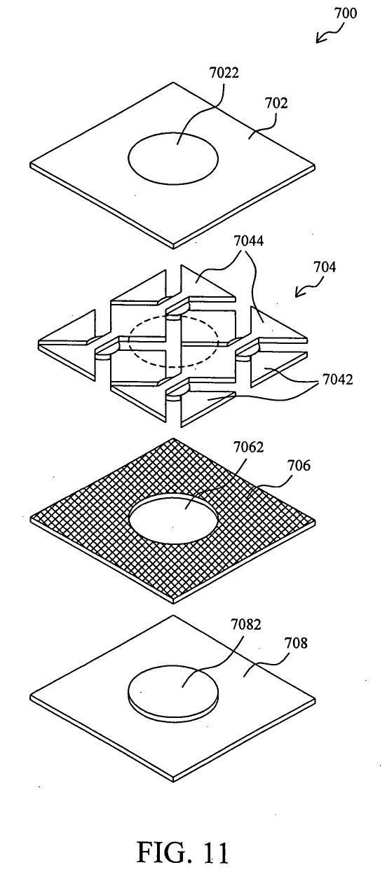

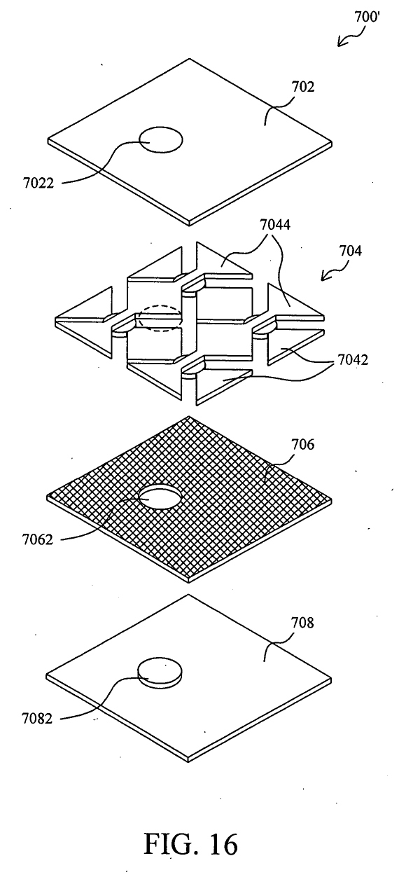

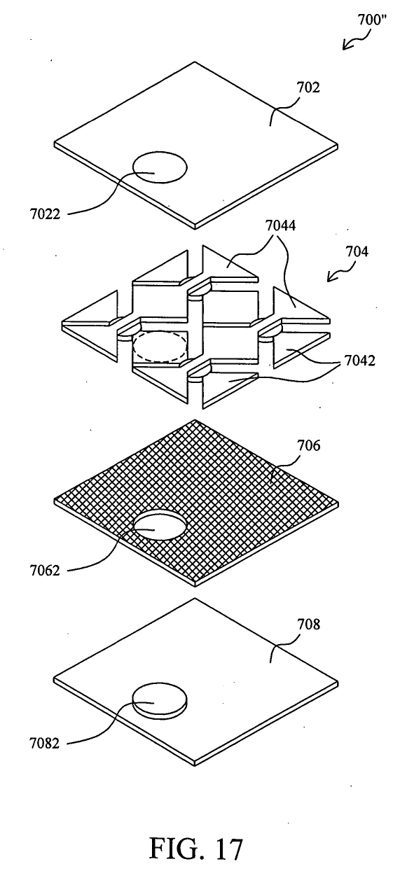

FIG. 11 is an exploded view of another capacitive touchpad 700 according to the present invention. There is a capacitance-sensing conductive layer 704 with a plurality of first axis wires 7042 and a plurality of second axis wires 7044 therein and an insulator layer 706 between the panel 702 and the substrate 708. A key area 7022 is on the panel 702. When a user presses the key area 7022, the wires 7042 and 7044 of the capacitance-sensing conductive layer 704 are pressed through the hole 7062 of the insulator layer 706 to contact the key operation conductor 7082 on the substrate 708. Wires 7042 and 7044 are connected through the key operation conductor 7082, and destroy the original charge and discharge mechanism to cause variation in potential to trigger a predetermined function. In such a structure, the number and position of the hole 7062 on the insulator layer 706 vary upon request, as the capacitive touchpad 700 in FIG. 11, in which the hole 7062 on the insulator layer 706 covers two first axis wires 7042 and two second axis wires 7044. The capacitive touchpad 700′ in FIG. 16 has a hole 7062 on the insulator layer 706 to cover one first axis wire 7042 and one second wire 7044. The capacitive touchpad 700″ in FIG. 17 has a hole 7062 on the insulator layer 706 that covers only on first axis wire 7042. The insulator layer 706 can be formed of insulator balls.

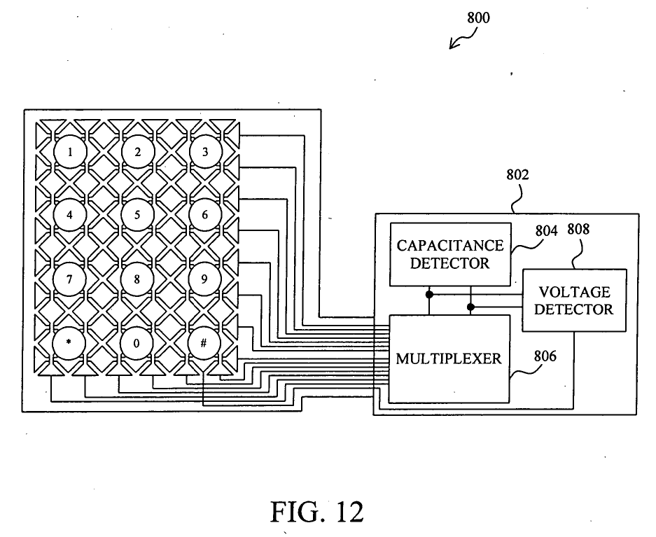

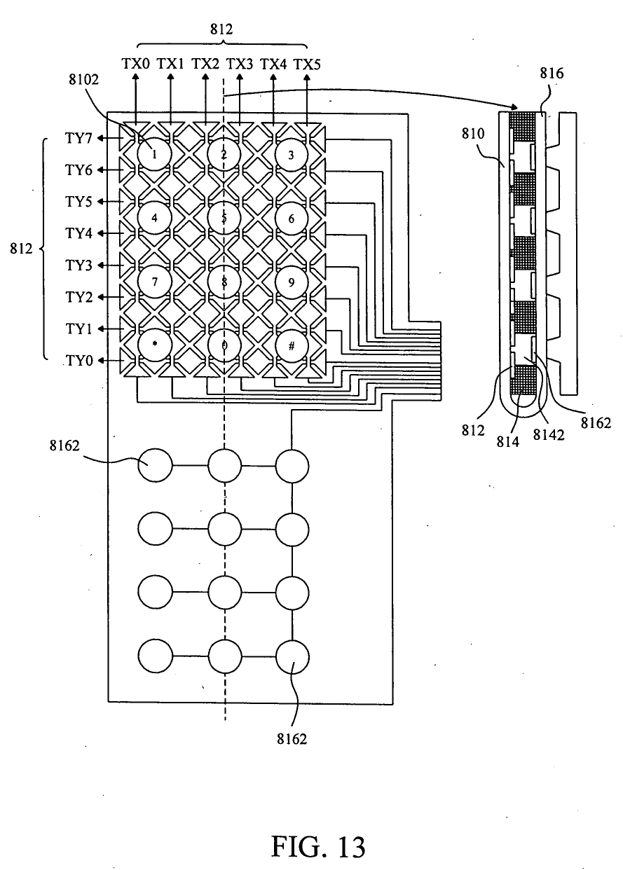

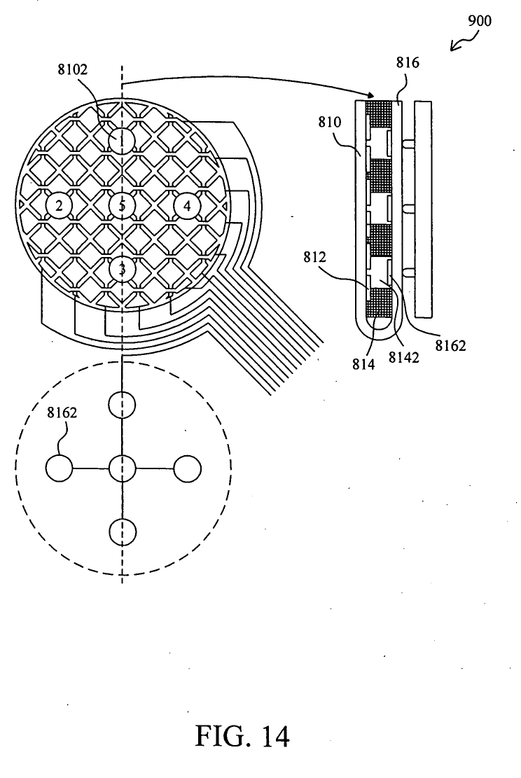

FIG. 12 illustrates an embodiment using the structure in FIG. 11 as an input apparatus of a mobile phone or a phone. FIG. 13 is the expanded view of the input apparatus 800. In the control device 802 of the input apparatus 800, the capacitance detector 804 couples to the first axis wires TX0 to TX5 and second axis wires TY0 to TY7 of the capacitance-sensing conductive layer 812 through a multiplexer 806 to provide a current to the parasitic capacitor of the capacitance-sensing conductive layer 612 to generate a voltage. When a user's finger touches the panel 810, the capacitance detector 804 detects the parasitic capacitance of the first axis wires TX0 to TX5 and second axis wires TY0 to TY7 to generate minor changes and to detect the position of the finger and the trace of motion. When the uses presses the key area 8102 on the panel 810, the capacitance-sensing conductive layer 812 contacts the key operation conductor 8162 on the substrate 816 through the hole 8142 on the insulator layer 814 to trigger the predetermined key function. To save power, standby mechanism can be implanted in the input apparatus 800. When the control circuit 802 enters a standby mode, the key operation conductor 8162 pulls the potential to high or low by using pull-up or pull-down resistor. The capacitance-sensing conductive layer 812 also shifts to a low or a high voltage level to enter the most power-saving mode. To wake up the control circuit 802, the key can be pressed to cause the capacitance-sensing conductive layer 812 to contact the key operation conductor 8162. The potential detector 808 detects the voltage change of the key operation conductor 8162 or the capacitance-sensing conductive layer to wake up the control circuit 802. When the present invention is utilized in different electronic devices, the shape and the number of keys can vary, as the input apparatus 900 shown in FIG. 14.

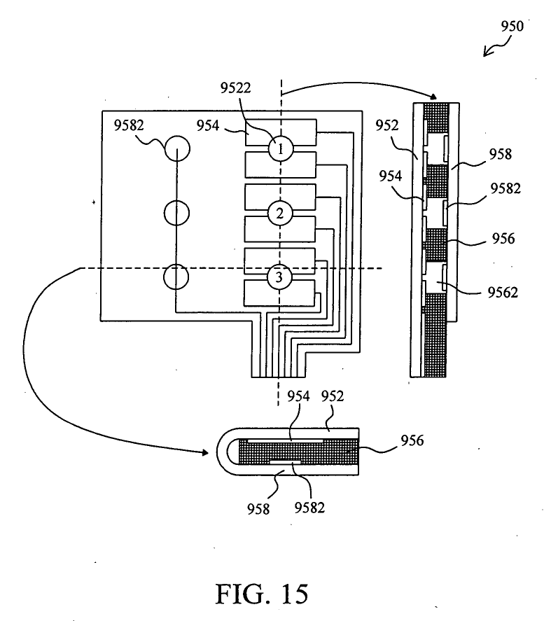

The structure in FIG. 11 can be used in a one-dimensional structure, as the capacitive touchpad 950 in FIG. 15. The capacitance-sensing conductive layer 954 and the insulator layer 956 are disposed between the panel 952 and the substrate 958. The capacitance-sensing conductive layer 953 has a plurality of wire aligned to one direction. When a user presses the key area 9522 on the panel 952, the capacitance-sensing conductive layer 954 couples the key operation conductor 9582 on the substrate 958 through the hole 9562 in the insulator layer 956 to trigger the predetermined function.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A capacitive touchpad with physical key function, comprising:
a soft flexible first conductive layer;
a second conductive layer; and
a soft flexible insulator layer, disposed between the first and the second conductive layers, with at least a through hole for the first conductive layer connecting the second conductive layer while the touchpad is pressed to trigger a predetermined key function.

2. The touchpad of claim 1, wherein the first conductive layer comprises an axis sensor.

3. The touchpad of claim 2, wherein the second conductive layer comprises a second axis sensor.

4. The touchpad of claim 2, wherein the potential sensor detects the potential variation of the first or the second conductive layer to active the standby touchpad.

5. The touchpad of claim 1, wherein the first conductive layer comprises a first axis sensor and a second axis sensor.

6. The touchpad of claim 5, wherein the first conductive layer is a capacitive induction conductive layer.

7. The touchpad of claim 5, wherein the potential detector detects the potential variation of the first or the second conductive layer to active the standby touchpad.

8. The touchpad of claim 1, wherein the second conductive layer comprises soft flexible material.

9. The touchpad of claim 3, further comprising:
a first detector to detect the parasitic capacitance change of the first and the second conductive layers; and
a second detector to detect the voltage of the first conductive layer or the voltage of the second conductive layer.

10. The touchpad of claim 9, wherein the capacitive detector provides a first current to charge and discharge the first and the second conductive layers and to generate a voltage between the first and the second conductive layers.

11. The touchpad of claim 9, wherein the potential detector provides a first voltage to the first conductive layer and a second voltage to the second conductive layer.

12. The touchpad of claim 6, further comprising:
a first detector to detect the parasitic capacitance change of the first and the second axis sensors; and
a second detector to detect the voltage of the first conductive layer or the voltage of the second conductive layer.

13. The touchpad of claim 12, wherein the capacitive detector provides a first current to charge and discharge the first conductive layer to generate a voltage.

14. The touchpad of claim 12, wherein the potential detector provides a first voltage to the first conductive layer and a second voltage to the second conductive layer.

15. The touchpad of claim 1, wherein the insulator layer comprises a plurality of insulator balls.
